(19) United States
(12) Patent Application Publication
(10) Pub. No.: US 2010/0169038 A1
(43) Pub. Date: Jul. 1, 2010

(54) METHODS FOR CALCULATING PARTICLE SIZE DISTRIBUTION

(75) Inventors: Christos Georgakis, Waban, MA (US); Sze Wing Wong, Marlborough, MA (US)

Correspondence Address: Casimir Jones, S.C., 2275 DEMING WAY, SUITE 310, MIDDLETON, WI, 53562, US

(73) Assignee: TUFTS UNIVERSITY, Boston, MA (US)

(21) Appl. No.: 12/597,134

(22) PCT Filed: Apr. 23, 2008
(86) PCT No.: PCT/US08/61243

§ 371 Date: Mar. 11, 2010

Related U.S. Application Data
(60) Provisional application No. 60/925,749, filed on Apr. 23, 2007.

(51) Int. Cl. G06F 15/00; G06F 17/18

(52) U.S. Cl. 702/128; 702/181

(57) ABSTRACT

The present invention provides processes employing algorithms and methods for calculating particle size distribution. In particular, the present invention provides processes employing algorithms and methods for calculating particle size distribution of different particle shapes from chord length distributions.

The present application claims priority to U.S. Provisional Patent Application Ser. No. 60/925,749 filed Apr. 23, 2007, the disclosure of which is herein incorporated by reference in its entirety.

### FIELD OF THE INVENTION

The present invention provides processes employing algorithms and methods for calculating particle size distribution. In particular, the present invention provides processes employing algorithms and methods for calculating particle size distribution of different particle shapes from chord length distributions.

### BACKGROUND OF THE INVENTION

Information regarding the time-evolving Particle Size Distribution (PSD) of a product is of crucial importance in any crystallization process. The final PSD not only directly affects the ease of handling in downstream processes; it also affects product quality (e.g., dissolution rate of an active pharmaceutical ingredient (API)).

Moreover, the direct/indirect measurement of the PSD in real-time provides valuable information including, but not limited to, nucleation and growth kinetics. With the understanding of the crystallization kinetics, the PSD is controlled on-line within specifications, provided the real-time measurements of PSD and solute concentration are made available.

There are currently two-direct/indirect on-line PSD measurement technologies; on-line imaging and Focus Beam Reflectance Measurement (FBRM). Real-time images of the crystals/slurry are obtained via a microscope equipped with a digital camera (photo-microscopy), or directly with a monochrome CCD video camera and light source. When on-line imaging is applied to the crystallizer, the video microscope is positioned at the sight-glass in a sampling loop (Patience and Rawlings, 2001, AIChE J. 47:2125-2130), or is mounted on the side of the crystallizer through a sight-glass (And a et al., 2005, J. Process Control 15:785-797; Larsen et al., 2006, Chem. Eng. Sci. 61:5236-5248; Larsen et al., 2007, Che. Eng. Sci. 62:1430-1441), or directly inserted into the crystallizer (Qu et al., 2006, J. Crystal Growth 289:286-294). Once the images are acquired, image analysis techniques are applied to extract information, such as the width/length of particles, aspect ratio, and roundness of particles, without any assumption on crystal shapes (And a et al., 2005; Qu et al., 2006). However, the usefulness of on-line imaging is limited to the resolution of the images. When the contrast between the particle and the solvent is low, or as particles overlap each other, current image analysis techniques fail to identify individual particles. As a result, the sample may either need to be diluted or more elaborate estimation methodologies are needed for image analysis.

Recent efforts were made to address the above problem by using a model-based object recognition algorithm (Larsen et al., 2006; Larsen et al., 2007). When the information of the crystal shape is provided, a model of the particular crystal shape is projected onto the image to estimate particle size and hence reduce the probability of type I and type II errors.

Nevertheless, when the algorithm is applied at medium to high solids concentrations, false positive errors constitute approximately half of the identified crystals by human operator. To improve the reliability of on-line imaging, significant additional research is needed in the area.

An alternative technology to indirectly measure PSD is by use of FBRM, which has become the widely used analytical measurement to study crystallization processes. The FBRM measurement does not provide information about PSD, but instead measures the chord length distribution of the particles. Focal bean reflectance measurement (FBRM) utilizes a focused laser beam that scans in a circular path. As the light scans across the particles passing in front of the probe window, light is scattered in all directions. The light that is scattered back towards the probe measures a chord length distribution (CLD) off the given particle (Sparks and Dobbs, 1993, Part. & Part. Syst. Charac. 10:279-289; Tadayyon and Rohani, 1998, Part. & Part. Syst. Charac. 15:127-135; Ruf et al., 2000, Part. & Part. Syst. Charac., 17:167-179). An advantage of using FBRM is that it can be inserted directly into the crystallizer with dense slurry and the measured data count can be used to isolate the size range in which a change occurred (Patience and Rawlings, 2001; Barrett et al., 2002, Trans. I. Chem. E. 80:799-805).

There are numerous research studies in converting the measured CLD to PSD. Early attempts focused on the conversion on spherical and ellipsoidal particles (Sparks and Dobbs, 1993; Simmons et al., 1999, Powder Tech. 102:75-83; Wynn, 2003, Powder Tech. 133:125-133. Other efforts correlated the mean and median chord length with particle size obtained by other offline measurement techniques (Heath et al., 2002, Part. & Part. Syst. Charac. 19:84-95). However, many crystallization products, especially in the pharmaceutical industry, are often non-spherical and most likely result in a needle shape. In order to convert the CLD of non-spherical particles into the corresponding PSD, knowledge of the relationship between PSD and CLD with a given crystal shape is required. Although there exists analytical methods to calculate CLD/PSD relationships for spherical and ellipsoidal particles, only numerical methods exists to calculate CLD/PSD relationship with non-spherical system (Ruf et al., 2000; Hukkanen and Braatz, 2003, Sensors and Actuators B 96:451-459; Li and Wilkinson, 2005, Chem. Eng. Sci. 60:3251-3265; Li et al., 2005, Chem. Eng. Sci. 60:4992-5003; Worlitschek et al., 2005, Part. & Part. Syst. Charac. 22:81-98; Pons et al., 2006, Chem. Eng. Sci. 61:3962-3973). Once the relationship between PSD and CLD (also known as the conversion matrix) is known, the conversion matrix is inverted to calculate PSD given the measured CLD. Nevertheless, the ill-conditioned nature of the conversion matrix, especially for a needle system, makes the inverse modeling method highly inaccurate.

As such, what are needed are calculations and methods for accurately determining particle size distribution, especially when coexisting particles in a sample are not shaped the same.

### SUMMARY OF THE INVENTION

The present invention provides processes employing algorithms and methods for calculating particle size distribution. In particular, the present invention provides processes employing algorithms and methods for calculating particle size distribution of different particle shapes from chord length distributions.

In one embodiment, the present invention comprises a computer process, referred hereafter as the Forward Particle Size Distribution Method (FPSDM, or Forward Modeling Method) and methods thereof, developed to convert Chord Length Distribution (CLD) obtained from a Focus Beam Reflectance Measurement (FBRM) instrument, or other similar analytical equipment, into a Particle Size Distribution (PSD). The PSD is a critical piece of information needed to control the quality of commercial products either off-line or on-line and in real time in different polymerization, crystallization, and other similar chemical processes. In some embodiments, the FPSDM estimates the PSD from the measured CLD accurately and with small computational time. It is different from the existing methods such as regularization (Hukkanen & Braatz, R. D., 2003) and projection over convex sets (POCS) (Worlitschek et al., 2005), which try to invert a rank deficient matrix relating PSD to CLD based on a single given crystal shape. The advantage of the FPSDM is that it does not need to invert the ill-conditioned conversion matrix (Ruf et al., 2000). In some embodiments, the invented FPSDM estimates a PSD that does not have an oscillatory behavior when one is not warranted. In some embodiments, the FPSDM avoids the calculation of erroneous negative number of particles for a given size range. In some embodiments, the computation time of the algorithm and methods of the present invention is preferably less than one minute and the data acquisition time is preferably less than ten seconds. In some embodiments, the processes and methods of the present invention are easily applied as an add-on calculation to the on-line FBRM measurement. In some embodiments, instead of following a rigid operating procedure in a given process, the present invention provides for the use of a variety of additional operation procedures for significantly improving the performance of all pharmaceutical, chemical, food, or other related processes.

In some embodiments, a first consideration of the FPSDM is to select generalized probability density functions which best describes the desired PSD. In some embodiments, this selection is made from a set of generalized distributions including, but not limited to, Gamma, Weibull, Parteo, and the like. Further, in some embodiments the second consideration is the estimation of the distribution parameters to match the measured CLD. When performed in real time, this calculation is used to detect the generation of new particles due to primary or secondary nucleation steps. In some embodiments, the processes of the present invention accurately estimate PSD that have a multimodal characteristic (FIG. 1). In other embodiments, the FPSDM estimates the PSD of two coexisting types of crystal shapes (FIG. 2).

### DESCRIPTION OF THE FIGURES

FIG. 1 is exemplary of FPSDM estimation of original PSD, with multimodal characteristics.

FIG. 2 is exemplary of FPSDM estimations of two different particles systems with two different particle shapes (needle and plate).

FIG. 3 is exemplary of probability plots of six different probability density functions with estimated PSDs. The outer lines represent the 95% confidence level.

FIG. 4 is exemplary of an L-Kurtosis vs. the L-Skewness L moment diagram. It is demonstrated that the 3-Parameter Generalized Pareto is the best representation of the estimated PSDs.

FIG. 5 is exemplary of a PSD estimation using Gamma distribution, and the comparison with an unknown distribution as seen in Case VI.

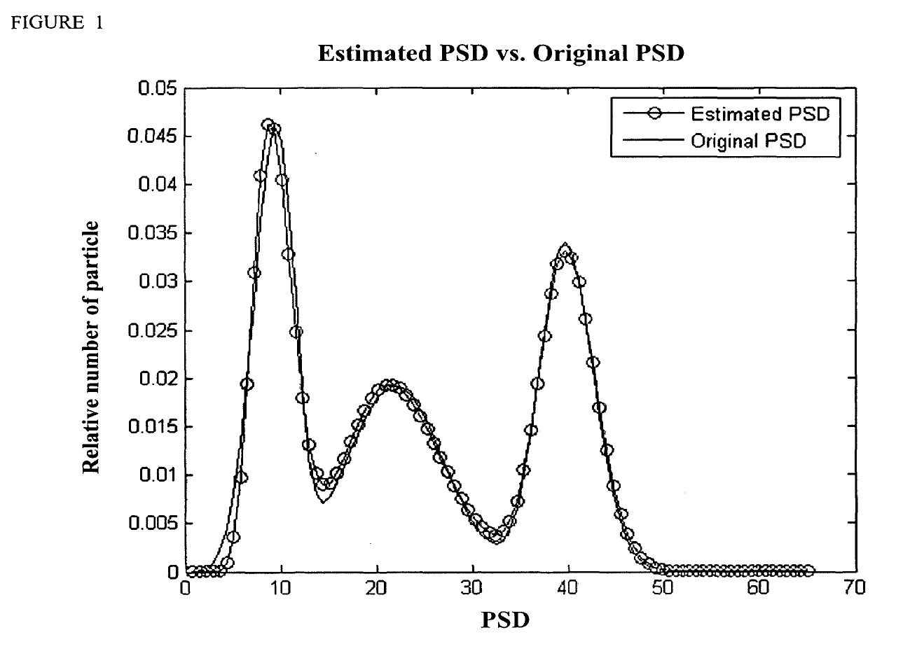

### DETAILED DESCRIPTION OF THE INVENTION

Certain illustrative embodiments of the invention are described below. The present invention is not limited to these embodiments.

The present invention provides processes employing algorithms and methods for the conversion of Chord Length Distribution (CLD) obtained from Focus Beam Reflectance Measurement (FBRM) into Particle Size Distribution (PSD).

To date, several techniques have been applied to solve the inverse modeling problem in spherical and octahedral systems. However, due to the rank deficiency characteristics of the inverted matrix, the inverse modeling method tends to be very sensitive to measurement noise, or gives physically meaningless PSD depending on the technique applied, especially in a needle particle shape system.

The algorithm and methods of the present invention avoid the aforementioned problem. The present invention provides embodiments, wherein some embodiments comprise a three-step procedure wherein the first step comprises the construction of a matrix for estimating the CLD given a PSD of crystals with known crystal shape. The matrix calculation is performed by rotating a three-dimensional geometric object that approximates the crystal shape, in space, to obtain a CLD with a mono-dispersed

PSD. The second step comprises assuming a probability density function representative of the true PSD. Finally, the last step comprises an estimation of the parameters in the probability density function by minimizing the error between the measured CLD and the calculated CLD, obtained by multiplying the matrix with the probability density function.
In order to quantify the conversion accuracy of an exemplary method of the present invention, the method is herein compared with an inverse modeling method in eight different simulated cases, and with real FBRM measurements, from one of the ten crystallization experiments performed in developing embodiments of the present invention. In some embodiments, calculated PSDs from the experimental cases are compared with the result obtained by image analysis via a microscope.

It is herein demonstrated that the algorithm and methods of the present invention demonstrate better agreement with the image analysis result than previous methods.

In one embodiment, the present invention provides a method herein referred to as the “forward modeling method”, embodiments of which were developed to address the ill-conditioned nature of the conversion matrix with, for example, a crystalline needle size system. Once the conversion matrix of a needle system (or any other) is obtained for example, a probability density function is assumed to describe the PSD. As the forward modeling method name implies, the conversion matrix is not inverted and avoids the problems associated with the rank deficiency of the pseudo-inverse, thereby resulting in high sensitivity.

### Conversion Matrix of the CLD/PSD Relationship

A chord length is measured when the rotating laser scans across a particle and the duration of the signal detected from the reflected light, along with the rotation speed, determines the chord length. Essentially, a chord length only represents a line between any two points on the edge of a particle and the laser does not necessarily pass through the center of the particle since the point of contact is arbitrary (Tadayyon and Rohani, 1998). As such, the conversion matrix represents the probability of measuring a particular CLD given a known PSD with a known crystal shape. In some embodiments, the method for constructing the conversion matrix is to calculate the CLD of a single particle size and scale it to the CLDs of all different particle size of interest, thereby constructing the crystal shape-specific conversion matrix used to calculate the CLD when the PSD is known. In some embodiments, in order to calculate what the CLD would be for a given particle size, a three-dimensional (3D) object that approximates the crystal shape and is approximately represented by Equation 1 is first generated,

$${\vert \frac{x}{a} \vert}^{k} + \vert \frac{y}{b} \vert + {\vert \frac{z}{c} \vert}^{k} = 1$$

where a, b, and c indicate the half-length of the three primary axes, and
wherein the values of the exponent k represents the sharpness of the corners.
Larger k values produce more rectangular shapes. The 3D object can be rotated in space and at every orientation its 2D projection is used to calculate a CLD. In some embodiments, the overall CLD of the model particle is obtained by normalizing the CLD at all orientations and weighted by the height along the y-axis of its 2D projection (Ruf et al., 2000).

There are two methods in the literature that differ from the above-described method. The first one generates only the 2D projection with Equation 1 by omitting the variables z and c. The method was validated with experimental systems that have spherical/ellipsoidal particles and was compared with results from image analysis (Li and

Wilkinson 2005; Li et al., 2005). The second method hypothesized that for any non-spherical particle, the orientation of a particle is a function of particle size, position of the probe and the flow characteristics. This second method requires an additional piece of information; an estimate of the orientation bias of the crystals of a specific system by running an experiment with known PSD along with the measured CLD. The drawback of the method is that it is dependent on the current fluid flow conditions and the orientation bias might change as nucleation and growth change the PSD with time.

In some embodiments of the present invention, after the conversion matrix, P, is obtained, the relationship between CLD and PSD can be represented mathematically. The measured CLD are collected in n bins that are specified by the FBRM instrument and is represented as a (n×1) vector, c as in Equation 2,

$$c = ( \begin{matrix}{c}_{1} \\ {c}_{2} \\ ⋮ \\ {c}_{n}\end{matrix} ) = ( \begin{matrix}c ( {L}_{1} , {L}_{2} ) \\ ⋮ \\ c ( {L}_{n - 1} , {L}_{n} )\end{matrix} )$$

wherein c (Lᵢ, Lᵢ₊₁) is the number of chord counts that have values within the chord size range Lᵢ<L<Lᵢ₊₁.
Furthermore, the PSD can be represented as a (m×1) vector, f, that is specified during the calculation of the conversion matrix as in Equation 3,

$$f = ( \begin{matrix}{f}_{1} \\ {f}_{2} \\ ⋮ \\ {f}_{m}\end{matrix} ) = ( \begin{matrix}f ( {L}_{1} , {L}_{2} ) \\ ⋮ \\ f ( {L}_{m - 1} , {L}_{m} )\end{matrix} )$$

wherein f(Lᵢ, Lᵢ₊₁) is the number of particles that has the characteristic crystal length within the size range Lᵢ<L<Lᵢ₊₁.

It should be noted that the conversion matrix, P is a (n×m) matrix. While n is specified by the FBRM instrument to be either 38 or 90 bins, m is defined by the user and depends on, for example, how much information is needed for the PSD. The relationship between CLD and PSD is then defined using the conversion matrix of Equation 4:

c=Pf

### Inverse Modeling Method

In some embodiments, methods of the present invention comprise calculating PSD from the measured CLD, wherein the conversion matrix P is inverted to obtain the PSD directly. However, in some embodiments, the conversion matrix is not a square matrix unless m=n. In some embodiments, for general cases and also for m=n, P is not of full rank. As such, the matrix P cannot be inverted, but its pseudo-inverse is used instead. Using the pseudo-inverse transforms the problem into a least square optimization problem by minimizing the residual in cases when n>m. The solution of the optimization problem is shown in Equation 5, where one inverts the matrix (P^{T}P) instead of inverting the matrix P:

f=(P^{T}P)⁻¹P^{T}*c

Nevertheless, it has been found that the pseudo-inverse is ill-conditioned in nature, such that a small perturbation of the data (e.g., measurement noise) leads to arbitrarily large perturbations of the solutions (Hukkanen and Braatz, 2003; Worlitschek et al., 2005). The solutions of calculated PSD from noisy measurement often result in oscillation and has a negative number of particles (Wynn, 2003; Worlitschek et al., 2005). Furthermore, Worlitschek et al. (2005) used the condition number to quantify the ill-conditioned nature of the conversion matrix and showed that the ill-conditioned nature of the problem worsens as the crystal shapes changes from spheres to needles (Worlitschek et al., 2005).
In some embodiments, the ill-conditioned nature of the conversion matrix is addressed using a constrained least square method or regularization method. The optimization problem is reformulated and the solution of the problem is as shown in Equations 6 and 7,

$${min}_{f} \frac{1}{2} ‖ Pf - c ‖ + λ ‖ Bf ‖$$

$$s . t . \\ f \geq 0$$

$$f = {( {P}^{T} P + λ {B}^{T} B )}^{- 1} {P}^{T} c$$

wherein λ is the regularization parameter, and wherein the values of λ determine the balance between how the matrix (P^{T}P+λB^{T}B) is well-conditioned and the biasness of the solution.

The matrix B is a smoothness constraint on the solution and is chosen as either the unitary matrix or as second order derivative operator (Hukkanen and Braatz, 2003; Worlitschek et al., 2005). Recently, the regularization method was applied to real FBRM data measuring PVC particles with reasonable results after accounting for the surface roughness of the PVC particles (Hukkanen and Braatz, 2003).

### Forward Modeling Method

The main difference between the forward modeling method and the inverse modeling method is that it avoids the rank deficiency characteristic of the pseudo-inverse matrix. As such, the estimated PSD does not have oscillating characteristics or negative values of the PSD. Moreover, the forward modeling method does not require a user to determine the optimization parameters such as λ and the smoothing matrix, B, which also avoids the trade-off between accuracy and smoothness of the estimated PSD.

In some embodiments, the forward modeling method comprises three-steps. The first step is to calculate the conversion matrix, P, using Equation 1 to generate different sizes of 3D objects that approximates the crystals and calculate the CLDs with a given crystal shape as previously described. In some embodiments, the calculation method of the conversion matrix, P, is the same as the inverse modeling method. The second step is to select a probability density function that has the potential to best describe the true

PSD. The third step is to estimate the parameters of the selected probability density function that give the minimal error residual between the estimated and measured CLD as shown in Equation 8,

$${min}_{d} ‖ Pf ( d ) - c ‖$$

wherein P is the conversion matrix,
wherein f is the probability density function,
wherein d is the variable of the unknown distribution parameters, and
wherein c is the measured FBRM data.

The forward CLD-to-PSD method as previously described focuses on systems with the estimated PSD defined by a single probability density function assuming an average aspect ratio that describes the crystal shape of interest. However, there are many instances in which a single probability density function is not sufficient to represent the true PSD, including, but not limited to, cases that have a bimodal distribution and more than one type of crystal present. In cases where the crystallization system has undergone secondary nucleation, polymorphic transformation, or another diastereomer has appeared in the slurry, a second probability density function is warranted to better represent the overall PSD of the system. In the case of a secondary nucleation, a second probability density function is introduced into Equation 8. The onset of secondary nucleation is marked at the time when FBRM records a jump in particle count and, in some embodiments, Equation 9 is then used instead of Equation 8,

$${min}_{{d}_{1} , {d}_{2}} ‖ Pf - c ‖$$

$$s . t . \\ \begin{matrix}f = f ( {d}_{1} , {d}_{2} , α ) \\ = α {f}_{1} ( {d}_{1} ) + ( 1 - α ) {f}_{2} ( {d}_{2} )\end{matrix}$$

$${μ}_{1} > {μ}_{2}$$

$$α \leq 1$$

wherein f1 represents the PSD of the crystals,
wherein f2 represents the PSD of the newly formed crystals, and
wherein α is the relative weight of the two PSDs.

Further, in some embodiments a constraint is added to the parameter estimation problem in which the average particle size of the seeds, μ₁, has to be greater than the average particle size of the nuclei, μ₂. This does not constraint the system since, as the two distributions converge, one has to be larger than the other. However, this constraint is enough to be used for repeated on-line calculations. In the case where there are two different types of crystals present in the system due to, for example, the appearance of a second polymorph or another diastereomer, the PSD of the system is estimated as found in Equation 10:

$${min}_{{d}_{1} {d}_{2}} ‖ α {P}_{a} {f}_{1} ( {d}_{1} ) + ( 1 - α ) {P}_{b} {f}_{2} ( {d}_{2} ) - c ‖$$

$$s . t . α \leq 1$$

wherein α is the fractional composition of the two different types of solids,
wherein Pₐ and P_{b} are the conversion matrix of the different types of solid, respectively.

### Probability Density Function Selection

In some embodiments, in order to quantify how well the PSD conforms to the hypothesized probability density function, the probability plot and L moment diagrams are used. Several probability density functions, for example, the normal distribution, lognormal distribution, the 2-parameters or the 3-parameters Gamma function, and the 2-parameters or the 3-parameters Weibull distribution, are first compared with each other in describing the true PSD using, for example, the probability plot as calculated using the statistical software, MINITAB 14.

In some embodiments, the Anderson-Darling goodness-of-fit test is used to test whether the PSD data is representative of the specified distribution (Stephens, 1974, J. Amer. Stat. Assoc. 69:730-737). Basically, the distribution using the least Anderson-Darling values, when the data points lie close to the centerline and within the 95% confident level interval in the probability plot, suggests the distribution best fits the PSD data. L moment diagrams are also used to compare how PSD data conforms to different 3-parameters and 2-parameters probability density functions (Vogel and Fennessey, 1993, Water Res. Research 29:1745-1752). L moment diagrams, along with the probability plot are used to select a 2-parameters and a 3-parameters probability density function, which is used to estimate the PSD from the FBRM measurements.

An exemplary demonstration of the applicability of the forward CLD-to-PSD method is herein described. In order to determine what type of probability density functions best fits the PSDs of a diastereomer resolution experiment, the conversion matrix, P is calculated by assuming an average aspect ratio of the needle-shaped crystal of the (S, R)-AD diastereomer to be 1:1:5 (width: depth: length). The conversion matrix is inverted and multiplied by the FBRM measurements from the experiment to have a rough estimation of the PSDs. Singular Value Decomposition (SVD), as defined by Equation 11,

P=DΣV^{T}

is performed on the conversion matrix. The approximated inverse matrix is also calculated with SVD using Equation 12,

(\hat{P})⁻¹=VᵣΣᵣ⁻¹Dᵣ^{T}

wherein D is the left singular vector,
wherein V is the right singular vector,
wherein Σ is the singular value matrix,
wherein the subscript, r, denotes the reduce size matrices obtained by keeping only the r as significantly non-zero singular values, and
wherein P⁻¹ is the inverted matrix calculated with truncated SVD.

Since the singular values are arranged in a descending order, the inverse matrix is sensitive to a singular value with small values. For an ill-conditioned matrix, at least one and possibly more, singular values are close to zero. As a result, inverting such matrices often increases the impact of measurement noise and gives oscillating PSD. To minimize the oscillation resultant in the calculated PSD, truncated SVD is used for the inversion. Truncated SVD uses a reduce number of singular values, which eliminates singular values that are close to zero, to approximate the original matrix and obtains P using above Equation 12 in conjunction with Equation 13 below.

$${\sum }_{r}^{- 1} = [ \begin{matrix}{σ}_{1}^{- 1} & 0 & 0 & … & 0 \\ ⋮ & 0 & ⋱ & & 0 \\ … & … & … & & {σ}_{k}^{- 1}\end{matrix} ]$$

The number of exact singular values to be kept in the truncated SVD is not easily determined. In some embodiments, an initial estimate is obtained by plotting the number of singular values vs. their index. When this is done, after the tenth singular value the remaining singular values have relatively small index values. As a result, only the first ten singular values are kept for the inversion with k=10 for Equation 13. It is important to note that the exact number of singular values needed is often difficult to quantify, and when not enough singular values are included, critical information of the matrix may be lost. Whereas when too many singular values are used, measurement noise is then incorporated in the approximation. Once the rough estimation of PSDs is obtained from the inverted matrix P, each of the measurements are modeled with all six different probability density functions and the probability plots of the residuals are then compared.

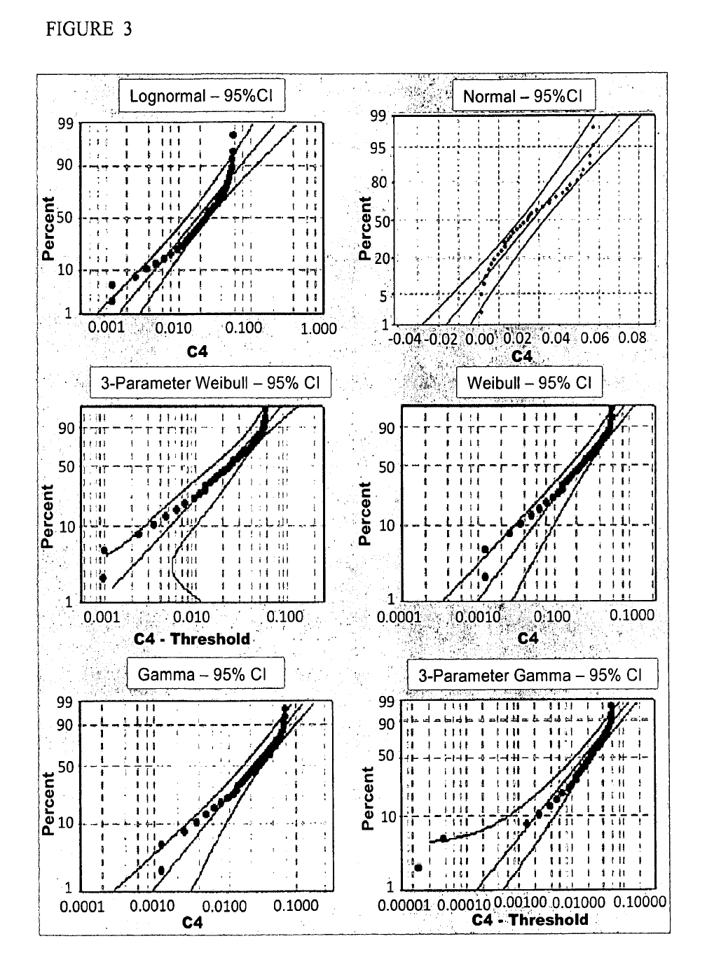

As can be seen in FIG. 3, from the probability plot and the Anderson-Darling test (Table 1), the 3-Parameter Weibull Distribution and the 2-Parameter Weibull Distribution have the best representation of the PSDs.

TABLE 1

| Probabiltiy Density Function | AD value |
|---|---|
| Lognormal Distribution | 1.202 |
| Normal Distribution | 0.707 |
| 3P Weibull Distribution | 0.565 |
| Weibull Distribution | 0.543 |
| 3P Gamma Distribution | 1.290 |
| Gamma Distribution | 0.590 |

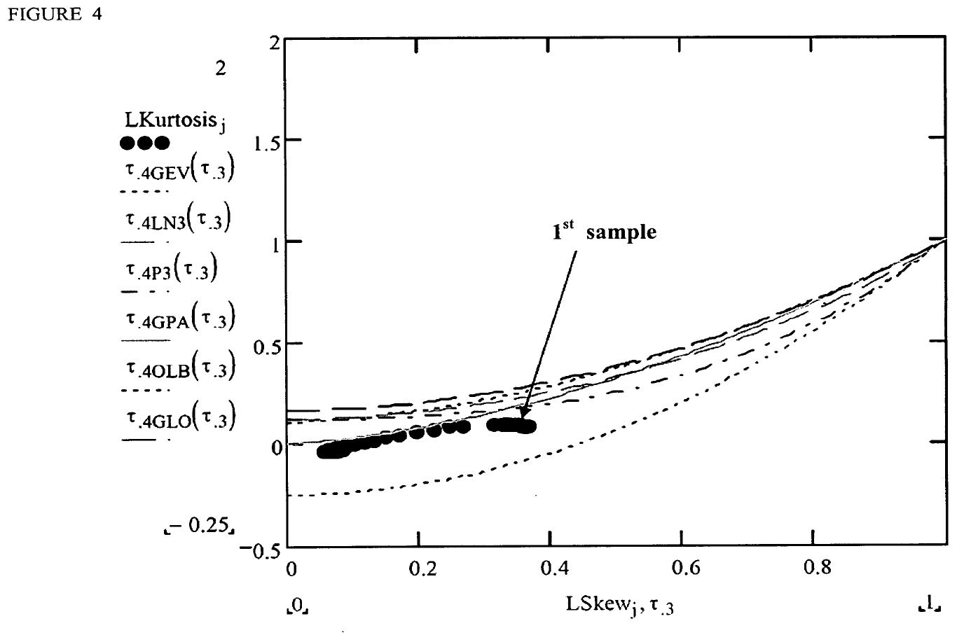

Since all the probability plots are calculated with the MINITAB 14 software program and has limited number of probability density function, the L moment diagrams are also used to compare additional 3-Parameter and 2-Parameter probability density functions (Vogel and Wilson, 1996, J. Hydro. Eng. 1:69-76). In the first L moment diagram (FIG. 4), the L-Kurtosis vs. the L-Skewness plot is used to compare six different 3-Parameter probability density functions, which consist of the Generalized Extreme Value (GEV), the 3-Parameter Lognormal (LN3), 3-Parameter Gamma Distribution (Pearson Type 3, P3), Generalized Pareto distribution (GPA), lower bound for all probability density functions (OLB), and Generalized Logistic (GLO). It was demonstrated that the 3-Parameter Generalized Pareto distribution best fits the estimated PSDs. When a second L moment diagram (L-Cv vs. the L-Skewness plot) is used to compare four different 2-Parameter probability density functions such as the 2-Parameter Lognormal (LN2), 2-Parameter Gamma distribution (GAM), 2-Parameter Weibull distribution (W2), and 2-Parameter Generalized Pareto (GP), it is demonstrated that the 2-Parameter Weibull distribution has the best overall representation of the estimated PSDs. Based on the results of the probability plots and the L moment diagrams, the Weibull distribution is selected as the 2-Parameter probability density function, Equation 14,

$${min}_{f} ‖ Pf - c ‖ , f = ( {f}_{1} , {f}_{2} , … , {f}_{m} )$$

$$s . t . f ( x ; k , λ ) = ( \frac{k}{λ} ) {( \frac{x}{λ} )}^{( k - 1 )} {e}^{- {( \frac{x}{λ} )}^{k}}$$

$$where$$

$${f}_{i} = {\int }_{{x}_{i - 1}}^{{x}_{1}} f ( x ; k , λ ) d {x}_{m}$$

$$i = 1 , 2 , … , m$$

$$and$$

$${x}_{i} - {x}_{i - 1} = ( {x}_{m} - {x}_{0} ) / m$$

wherein x≧0, λ>0 is the scale parameter of the distribution, and
wherein k>0 is the shape parameter of the distribution,
and the Generalized Pareto Distribution is selected as the 3-Parameter probability density function, Equation 15,

$${min}_{k , θ , σ} ‖ Pf - c ‖$$

$$s . t . f ( x ; k , θ , σ ) = ( \frac{1}{σ} ) {( 1 + k \frac{( x - θ )}{σ} )}^{- 1 \frac{1}{k}}$$

$$where$$

$${f}_{i} = {\int }_{{x}_{i - 1}}^{{x}_{1}} f ( x ; k , θ , σ ) d {x}_{m}$$

$$i = 1 , 2 , … , m$$

$$and$$

$${x}_{i} - {x}_{i - 1} = ( {x}_{m} - {x}_{0} ) / m$$

wherein σ is the scale parameter,
wherein k is the shape parameter, and
wherein θ is the threshold parameter.

As such, in some embodiments, both of the probability density functions are used to find the optimal solution of PSD by minimizing the error between the estimated CLD and the measured CLD (Equation 14 and Equation 15).

### CLD to PSD Conversion Examples & Discussion

The inverse modeling methods and the forward modeling method as previously discussed in were applied and compared in eight different simulated cases and two experimental test cases. The simulated cases were deemed important in order to evaluate the relative merits of the approaches. In all eight simulated cases, focus was placed on a needle crystal system and different realistic examples of particle size distributions (PSD) were assumed. Knowing the shape of the crystals, it was possible to calculate the CLD. It was contemplated that the experimentally measured CLD would be different due to the accuracy of the measurement. Both methods used the calculated CLD to back calculate the PSD, which was then compared with the original PSD. The two experimental test cases used the CLD measured by the FBRM instrument in one of the crystallization experiments in creation of compound A.

The estimated PSDs from both methods
were compared with the PSDs obtained via image analysis. It was contemplated that PSD differences were due to three potential influences; CLD measurement errors, conversion errors, and/or PSD measurement errors.

### Simulation Test Case: Case I to VIII

In the simulation cases I, II, and III, it was assumed that all the crystals have the same shape with an aspect ratio of 1:1:10 (needle shape) and that the characteristic of the PSDs was normally distributed. The bimodal PSD was assumed to be composed of two normally distributed PSDs (Equation 16)

$${f}_{i} ( x ; μ , σ ) = \frac{1}{{σ}_{i} \sqrt{2 π}} {e}^{\frac{- {( x - {μ}_{i} )}^{2}}{2 {σ}_{i}^{2}}}$$

with average particle sizes of μ₁ and μ₂, and standard deviations of σ₁ and σ₂. The PSDs were then weighted by the predetermined fractional composition, a in Equation 17.

f(d₁,d₂)=αf₂(d₂)+(1−α)f₂(d₂)

The conversion matrix, P(90×90), was calculated as discussed above using Equation 1, with the parameters set as a=b, c=10a, and k=10 for different particle sizes. The characteristic length was L=2ₐ. The simulated CLD was calculated using Equation 4, with 1% randomly distributed measurement noise added. Subscript i denotes the number of PSDs, x is the particle size range, d is the estimated parameters in the distribution, μ and σ represent the standard deviation and mean of the distribution respectively, and f denotes the final PSD vector used to calculate the simulated CLD in Equation 9.

In cases IV and V, the simulated CLD was calculated from two PSDs in each case. The pair of assumed PSDs represented crystals of different shapes. As a result, two conversion matrices, Pₐ and P_{b}, representing different crystal shapes were used for each particle shape (Equation 10). In case IV, the two PSDs assumed needle shape with slight differences in the aspect ratio. The main objective of case IV was to test whether the forward modeling method was sensitive to slight changes in aspect ratio. The first conversion matrix, Pₐ, assumed an aspect ratio of 1:1:10 while the second conversion matrix, P_{b}, assumed an aspect ratio of 1.05:1.05:10.5 with only 5% difference in the length of the needle. It was contemplated that the result from this simulation case would give an indication of the sensitivity of the result on the exact shape of the crystals. In simulation case V, the forward modeling method was used to recover the PSD of two very distinct crystal shapes given only the CLD measurement. The first PSD used to calculate the overall CLD was characterized by an aspect ratio of 1:5:5 (plate shape), while the second PSD was characterized by an aspect ratio of 1:1:10 (needle shape). This simulation case represents the situation in which polymorphic transformation takes place, and the method may be used to model such transformation kinetics.

The aforementioned simulated cases assume normal distributions in both the original PSDs and in the calculation. In order to avoid calculation bias and to test the applicability of a method of the present invention, the simulated cases VI, VII and VIII assume other “unknown” distributions that constitute the overall PSD. Since the number or types of distribution needed to calculate the CLD was not known, the forward modeling method was modified accordingly. The first step involved selecting a general probability density function to fit different distributions. The generalized 3-parameter Gamma distribution was selected and used in the optimization problem. As no initial conditions about the PSD were known (as is normally the case in experiments), an iterative process was introduced. The number of Gamma distribution needed to describe the overall PSD was determined iteratively by checking the error between the estimated CLD and the calculated one. If the error was larger than the specification, an additional Gamma distribution was added into the next calculation.

In test case VI, there were 2 unknown distributions used to calculate the CLD. The first calculation attempt used only one 3-parameter Gamma distribution and the residual error was used as a guide to check whether additional distribution was needed in the calculation. The procedure was repeated until the estimated CLD had good agreement with the calculated CLD. In test case VII, there were 3 unknown distributions used to calculate the CLD. The procedure described above was used to determine the number of distributions needed in the calculation. Finally, in case VIII, there were 4 unknown distributions used to calculate the CLD. Case VIII was designed to test the limitation of the methodology of whether there could be more than one solution in the optimization problem.

In case I, the overall PSD was chosen to have two equally weighted sharp peaks and the peaks are deliberately chosen not to overlap each other. The use of the sharp peaks was to test whether the methods examined could recover the original PSD without introducing any bias. In case II, the two PSDs, that compose the overall PSD, were chosen to have broader characteristics without overlapping with each other. The fractional weight percent between the two PSDs was chosen to be 0.3 such that the calculated CLD had unequal weight from each PSD. In case III, the overall PSD was constituted from two broad individual PSD, which had significant overlap.

When observing the calculated CLD, it is observed that the characteristic CLD of needle-shaped crystals was lost due to the overlapping PSDs. However, if the crystal shape of the system is known, the PSD could still be restored. The means and standard derivations of all five test cases are listed in Table 2.

TABLE 2
The mean and standard deviations of PSDs in Cases I-V

| | Mean of | stand. Dev. of | Mean of | Stand. Dev. | Fractional |
|---|---|---|---|---|---|
| Test Case | PSD1 | PSD1 | PSD2 | of PSD2 | Weight |
| I | 22 | 0.1 | 45 | 0.1 | 0.5 |
| II | 23 | 1.5 | 42 | 2.3 | 0.3 |
| III | 25 | 2.5 | 35 | 4 | 0.2 |
| IV | 20 | 1.8 | 44 | 0.1 | 0.46 |
| V | 23 | 1.3 | 60 | 3 | 0.3 |

For the Inverse Modeling method, also known as the regularization method, a small value of 0.01 was chosen for the parameter λ, and the second order derivative matrix was selected as matrix B for Equation.6. In the Forward Modeling Method, the probability density function was weighted by the fractional composition of two normal distributions.

The five parameters μ₁, σ₁, μ₂, σ₂ and α were estimated by finding the minimal residual error between the estimated CLD and the simulated CLD (Equation18).

$${min}_{{d}_{1} , {d}_{2}} ‖ Pf ( {d}_{1} , {d}_{2} ) - c ‖$$

$$s . t . {f}_{i} ( x ; μ , σ ) = \frac{1}{{σ}_{i} \sqrt{2 π}} {e}^{\frac{- {( x - {μ}_{1} )}^{2}}{2 {σ}_{i}^{2}}}$$

$$f ( {d}_{1} , {d}_{2} ) = α {f}_{1} ( {d}_{1} ) + ( 1 - α ) {f}_{2} ( {d}_{2} )$$

All five estimated parameters were compared with the original PSDs of all three test cases and the relative percent error (% Error) are listed in Tables 3 to 5.

TABLE 3
Test case I results from Forward Modeling Method

| | Mean of | stand. Dev. of | Mean of | Stand. Dev. | |
|---|---|---|---|---|---|
| | PSD₁ | PSD₁ | PSD₂ | of PSD₂ | Weight |
| FMM | 22.0 | 0.1 | 44.8 | 0.14 | 0.50 |
| % Error | 0.13 × 10⁻² | −0.39 | 0.54 | −36.70 | −0.200 |

TABLE 4
Test case II results from Forward Modeling Method

| | Mean of | stand. Dev. of | Mean of | Stand. Dev. | |
|---|---|---|---|---|---|
| | PSD₁ | PSD₁ | PSD₂ | of PSD₂ | weight |
| FMM | 23.0 | 1.5 | 42.0 | 2.3 | 0.3 |
| % Error | 0.2 × 10⁻² | −0.14 | 0.8 × 10⁻³ | −0.07 | −0.03 |

TABLE 5
Test case III results from Forward Modeling Method

| | Mean of | stand. Dev. of | Mean of | Stand. Dev. | |
|---|---|---|---|---|---|
| | PSD₁ | PSD₁ | PSD₂ | of PSD₂ | Weight |
| FMM | 25.0 | 2.5 | 35.0 | 4.0 | 0.2 |
| % Error | 0.01 | −0.22 | 0.13 × 10⁻³ | −0.06 | −0.20 |

The estimated PSDs of test case I from regularization and Forward Modeling methods were plotted along with the original PSD. It was observed that the regularization method estimated the means of the PSDs to be close to the original answer, but it overestimated the standard deviation of both PSDs. It was contemplated that this was due to the choice of using the second order derivative matrix for B. Although it might be possible to improve the result by using the identity matrix, it is at the expense of having a less smooth PSD. As for the Forward Modeling Method, the estimated PSD overlapped the original PSD with great precision. Although the % Error of the standard deviation of the second PSD is high, it was noted that the original answer of 0.1 compared with the estimated value of 0.136 still provided satisfactory results.

In the second test case, the regularization method demonstrated a better estimation of the PSDs. When the PSDs have broader peaks, the regularization method was able to better estimate the mean and standard deviation of the two models of the distribution. However, the regularization method still overestimated the finer region of the PSD and it also failed to estimate the fractional weight between the two PSDs. On the other hand, the Forward Modeling Method gave very accurate estimation of the PSDs and was able to estimate the relative weight, α, of the PSDs. Table 4 demonstrates the excellent agreement between the initially simulated and the estimated PSD characteristics, with minimal relative % error.

In test case III, the estimated PSDs from the regularization and Forward Modeling Method were plotted along with the original PSD. The estimated PSD from the regularization method roughly covers both the original PSDs. Although the regularization method had a relatively good agreement with one of the PSDs, it failed to predict the secondary PSD peak. For the Forward Modeling Method, the estimated PSDs once again overlapped over the original PSD. With the Forward Modeling Method, all four estimated parameters were compared with the original PSDs and the relative % percent error was less than 0.2%, as seen in Table 5.

As stated previously, in both case IV and V, the simulated CLDs took into account different crystal shapes. Since the regularization method was not formulated to address the above problem, only the forward modeling method was applied. It should be noted that because there were two different crystal shapes involved in the calculation, two different conversion matrices, Pₐ and P_{b}, were needed in the parameter estimation. The five parameters μ₁, σ₁, μ₂, σ₂ and a were estimated by finding the minimal residual error between the estimated CLD and the simulated CLD using Equation 19.

$${min}_{{d}_{1} , {d}_{2}} ‖ α {P}_{a} {f}_{1} ( {d}_{1} ) + ( 1 - α ) {P}_{b} {f}_{2} ( {d}_{2} ) - c ‖$$

$$s . t . {f}_{i} ( x ; μ , σ ) = \frac{1}{{σ}_{i} \sqrt{2 π}} {e}^{\frac{- {( x - {μ}_{1} )}^{2}}{2 {σ}_{i}^{2}}}$$

$$f ( {d}_{1} , {d}_{2} ) = α {f}_{1} ( {d}_{1} ) + ( 1 - α ) {f}_{2} ( {d}_{2} )$$

$$α \leq 1$$

In test case IV, the primary objective was to check the sensitivity of the forward modeling method with crystals having similar aspect ratio. As such, another conversion matrix was calculated assuming 5% different in the length of the needle crystal. The first PSD assumes a needle with an aspect ratio of 1:1:10, while the second PSD assumes an aspect ratio of 1.05:1.05:10.5. The CLD was simulated using the combined PSDs with the parameters listed in Table 2. The first calculation estimated the parameter using two different conversion matrices (Equation 19). The results in Table 6 show that the Forward Modeling Method accurately predicts the PSDs of both needle systems.

TABLE 6
First and second calculation results in case IV

| | | stand. | | Stand. | |
|---|---|---|---|---|---|
| | Mean of | Dev. of | Mean of | Dev. | |
| | PSD1 | PSD1 | PSD2 | of PSD2 | Weight |
| Answer | 20 | 1.8 | 44 | 0.1 | 0.46 |
| Cal. With Pₐ and P_{b} | 20.00 | 1.80 | 43.82 | 0.10 | 0.46 |
| Cal. With Pₐ only | 20.00 | 1.79 | 43.82 | 0.10 | 0.46 |

In the second calculation (PSD2), only one conversion matrix was used to estimate the parameters (Equation 18). If the Forward Modeling Method was sensitive to the assumed aspect ratio, the estimated PSDs would be different from the answer. In Tables 6 and 7, the results from using one conversion matrix shows that there is only negligible difference between both calculations.

TABLE 7
% error of first and second calculation results in case IV

| | | stand. | Mean | Stand. | |
|---|---|---|---|---|---|
| | Mean of | Dev. of | of | Dev. of | |
| | PSD1 | PSD1 | PSD2 | PSD2 | Weight |
| Cal. With Pₐ and P_{b} | 0.13 × 10⁻² | −0.14 | −0.40 | 0 | −0.02 |
| Cal. With Pₐ only | −0.01 | −0.71 | −0.41 | 0 | 0.46 |

As such, this example demonstrates that the forward modeling method is not sensitive to slight changes in aspect ratio of crystals with similar shapes.

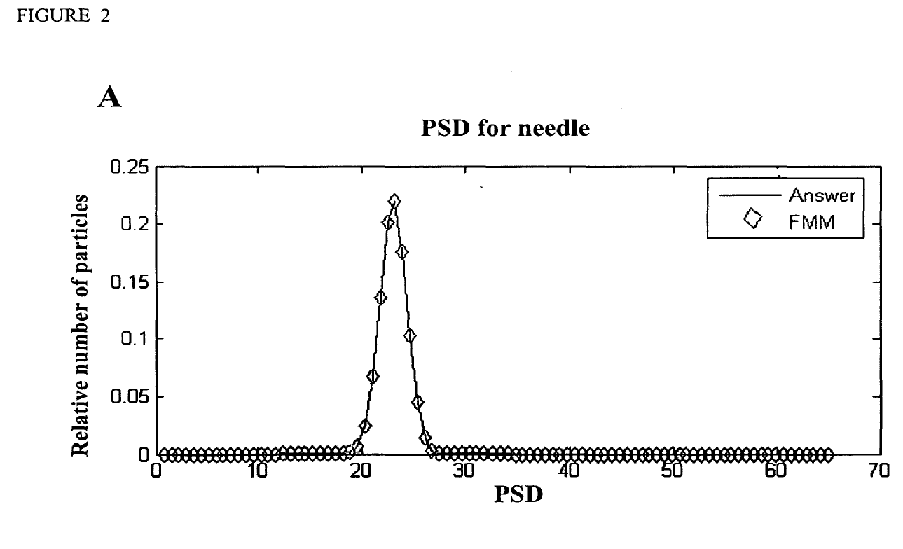

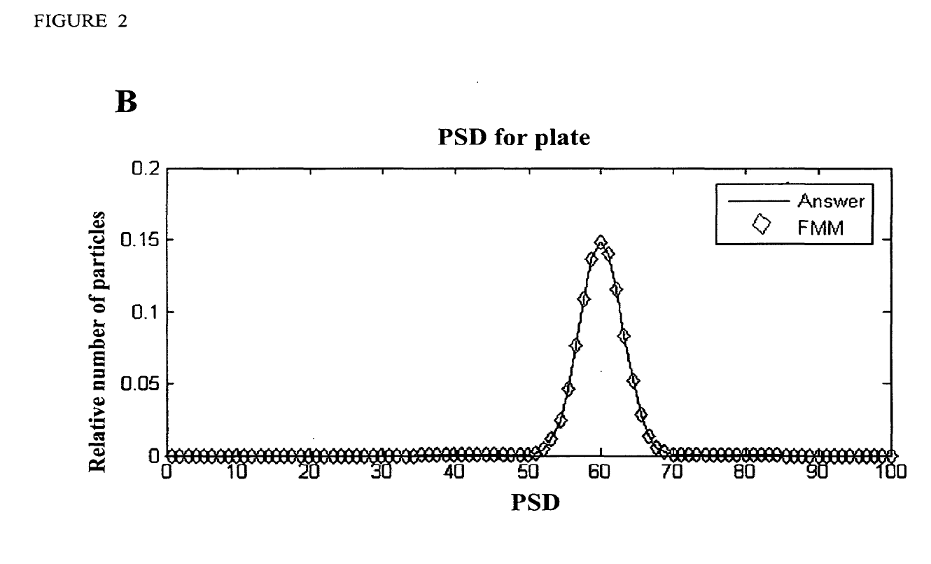

In test case V, the simulated CLD was calculated from two PSDs, each with a distinct crystal shape (needle and plate). The aspect ratio of the two types of crystals was 1:1:10 and 1:5:5. The Forward Modeling Method was used to test whether it was able to restore the 2 different PSDs of each crystal shape. Results demonstrated that the Forward Modeling Method successfully estimated the PSDs of both crystal shapes (FIG. 2). This was an important finding as the example demonstrates that the Forward Modeling Method is applicable to more complex crystallization systems than the regularization method, which has been limited in addressing a population of a single shape. As such, in some embodiments the forward modeling method of the present invention is used to estimate the crystallization kinetics of polymorphic transformation or diastereomer resolution.

The objective of cases VI to VIII was to test the applicability of the forward modeling method wherein the number, or the types, of distribution used to represent the overall PSD are unknown. To address the problem, the forward modeling method becomes an iterative process. The first step was to find a generalized probability density function for approximating most of the PSDs. The generalized 3-Parameter Gamma distribution was chosen to estimate the overall PSD in the case studied. Then, the iterative process began by first using only one Gamma distribution in the calculation. If the residual error between the estimated and calculated CLD was larger than 0.01, the calculation was repeated by adding an additional Gamma distribution until the residual error was satisfactory (Equation 20),

$${min}_{{d}_{1} , … {d}_{i}} E = ‖ Pf ( {d}_{1} , {d}_{2} , … , {d}_{i} ) - c ‖$$

$$s . t . {f}_{i} ( x ; k , θ , β ) = \frac{β}{Γ ( k ) θ} {( \frac{x}{θ} )}^{k β - 1} {e}^{- {( \frac{x}{θ} )}^{β}}$$

$$f ( {d}_{1} , … , {d}_{i} ) = f ( {d}_{1} ) + f ( {d}_{2} ) + … + f ( {d}_{1} )$$

$$i = 1 , 2 , … , 4$$

$$E \leq 0.01$$

$$where$$

$$Γ ( k ) = {\int }_{0}^{∞} {x}^{k - 1} {e}^{- x} d x$$

wherein E is the residual error,
wherein d is the estimated parameters in the generalized Gamma distribution,
wherein x is the particle size range,
wherein Γ is the gamma function,
wherein θ is a scale parameter, and
wherein β and k are the shape parameters.

In Case VI, the overall PSD was composed of a Weibull distribution and a Gamma distribution. However, it was assumed that it was not knows what constituted the overall PSD, and the generalized Gamma distribution was used. It was observed that when only one Gamma distribution was used, the estimated CLD had poor agreement with the calculated CLD. Furthermore, Table 8 shows that the residual error

failed the specification and so a second gamma distribution was added.

TABLE 8
Residual error of case VI

| Number of Distributions Used | Residual Error |
|---|---|
| 1 | 0.11 |
| 2 | 7.7 × 10⁻³ |

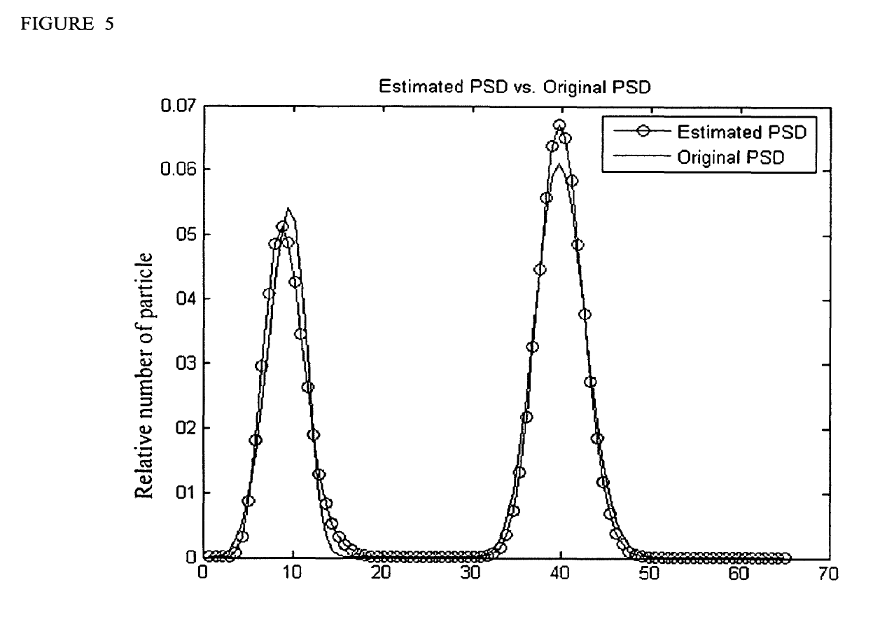

The results show that a second distribution was needed to sufficiently represent the overall PSD and the residual error also satisfied the specification of less than 0.01 as listed in Table 8. Finally, the estimated PSD was compared with the “unknown” PSD and it was observed that the Gamma distribution had good agreement with the overall PSD (FIG. 5).

In case VII, the three different distributions that composed the overall PSD were Gamma, Weibull, and Normal distribution. Once again, the Generalized Gamma distribution was assumed in the calculation and the residual errors are listed in Table 9 from using two or three Gamma distributions.

TABLE 9
Residual error of case VII

| number of distributions | Residual Error |
|---|---|
| 2 | 0.125 |
| 3 | 0.005 |

It is demonstrated from Table 6.9 that two distributions were not enough to represent the overall PSD as the residual error failed the specification. Finally, as seen in FIG. 5, the three generalized gamma distributions accurately estimated both the calculated CLD and the original PSD in case VII.

It should be noted that while cases VI and VII proved that the generalized Gamma distribution was capable of describing other unknown distributions, the iterative process described above successfully determined the number of distributions needed.

Case VIII was designed to test the limitation of the forward modeling method. A complicated PSD was designed, composed of four different distributions. An interesting result from the calculation was that while the estimated CLD agreed very well with the calculated CLD that has a residual error of 0.98, the estimated PSD failed to describe the original PSD. This finding suggests the possibility that more than one PSD results in the same CLD.

In order to demonstrate whether multiple PSDs result in the same CLD, a similar PSD was constructed composed of four Gamma distributions. The forward modeling method was applied with the generalized gamma distribution to back calculate the original PSD. Two calculations with two different initial suppositions were used to estimate the original PSD. The residual errors from each calculation are listed in Table 10.

TABLE 10
Residual errors of case VIII with different initial suppositions

| | Residual Error |
|---|---|
| 1st Calculation | 1.1 × 10⁻⁴ |
| 2nd Calculation | 0.9 × 10⁻³ |

If the residual errors were examined separately, they would both pass the specification. Furthermore, the estimated CLDs were both very similar to the calculated CLDs with only slight differences. However, the initial estimated PSDs were very different from each other. It is very rare to have PSDs in any crystallization system with four different peaks as was used in our example. As such, the forward modeling method demonstrates satisfactory results when the overall PSD has three or less distributions.

### FBRM Measurement Data: Test Case IX & X

In a crystallization experiment, the FBRM measurements were separated into three different chord size ranges (1-1000 μm, 1-15 μm), and 15-100 μm) to study the trend of the secondary nucleation kinetics. The FBRM measurement began right after seeding occurred and it is observed in counts data that the seeds were initially growing (the number of particles remained relatively the same). However, as the degree of supersaturation of the (S, R)-AD diastereomer remained relatively high and the crystal growth rate of the seeds was not enough to consume the supersaturated solution, secondary nucleation was observed 30 minutes into the experiment. The goal of this test case was to study how the proposed method and the FBRM measurements may be affected by slurry density. In the first sample collected, slurry density defined as the mass of crystals over solution volume was estimated to be 3.9 mg/mL. As secondary nucleation occurred, slurry density increased and it was measured to be 24.8 mg/mL in the second sample. The CLD measured at the time the samples were drawn from the crystallizer was used in the conversion problem. The estimation results from 2-parameter probability density function and the 3-parameter probability density function selected for the forward modeling method were first compared. In order to compare quantitatively the 2-parameter and 3-parameter probability density function, the prediction errors between the PSDs and CLDs were used as selection tools, as in Equation 21 and Equation 22

$${E}_{PSD} = {\int }_{0}^{∞} [ f ( L ) - \hat{f} ( L ) ] d L / {\int }_{0}^{∞} f ( L ) d L . \\ {min}_{d} {E}_{CLD} = ‖ Pf ( d ) - c ‖$$

wherein f(L) is the particle size of the original PSD, and
wherein f (L) is the particle size of the estimated PSD.

It was observed that in both cases, the 2-parameter Weibull distribution had slightly better estimation accuracy compared with the 3-parameter Generalized Pareto distribution. Although both probability density functions had similar PSD profiles in the second sample, they differed rather significantly in the first sample. The possible cause of why the 3-parameter Generalized Pareto distribution had worst fit compared with the 2-parameter distribution might be that the 1st sample in the L moment diagram slightly deviated from the distribution. As a result, the Weibull distribution was chosen to be the probability density function used to compare with the inverse modeling method.

The estimated 2-parameter Weibull distribution from the forward modeling method and the inverse modeling method were compared with the PSD obtained from image analysis of the 1st sample. It was clear that the regularization method underestimates the particle size. On the other hand, the forward modeling method had greater agreement with the PSD measured from the microscope. Although the forward modeling method slightly overestimated the tail end of the PSD, it was likely caused by the assumption of the constant average aspect ratio of all needles. This is better explained by calculating the CLD corresponding to the measured PSD with the conversion matrix. The calculated CLD is overlapped with the measured CLD, and it is clear that the calculated CLD had a smaller average chord length compared with the measured one. It was shown that the forward modeling method slightly overestimates the particle size by making a simplified assumption of applying a constant aspect ratio for all needles.

In the PSD estimation of the second sample, it was shown that both of the methods underestimated the particle size compared with the measured PSD. It should be noted that the 2nd sample was taken after secondary nucleation occurred and the measured slurry density has significantly increased from 3.9 mg/mL to 24.8 mg/mL.

Furthermore, the increase in particle counts from the FBRM measurement suggested that many more small crystals resulted from nucleation were presented. It has been documented that when the F-fine mode for electronic signal processing is used, the
FBRM measurement becomes more sensitive to smaller particles as slurry density increases (Ruf, Worlitschek et al. 2000). It is shown that the FBRM measurement tends to underestimate the chord length in dense slurry (Ruf, Worlitschek et al. 2000). The increase in counts for small particles is due to the weakening and broadening of the laser beam, which makes it more difficult for the signal processing to detect precisely the boundary of the particle. This problem may be addressed either by selecting the C-coarse mode (less sensitive to fine particles) for electronic signal processing or to adjust the location of the focal point of the laser. However, if the FBRM measurement is needed to study a nucleation event, the C-coarse model may not be sensitive enough to detect the onset of nucleation.

If, on the other hand, it was decided to adjust the position of the focal point of the laser to have better measurement of the fine particles, the focal point can be adjusted to be just past the probe window (Sparks and Dobbs 1993; Worlitschek and

Mazzotti 2003). Nevertheless, the new location of the focal point is now sensitive to the solvent system and it is also not optimal to measure large particles. The optimal focal point location changes with different sizes of particles (Worlitschek and Mazzotti 2003).
As a result, the manufacturer suggests the optimal focal point of the laser should be at the probe window, which is the same setup as in the experiment. In addition, the calculated CLD using the measured PSD of the 2nd sample indicates the possibility of the measured CLD underestimated the chord length. The simulated CLD also explained why all the methods failed to accurately estimate PSD of the 2nd sample. The estimation result of the second sample demonstrated how the FBRM measurement is affected by slurry density. As slurry density increases, the FBRM measurement tended to overestimate the fine particles due to the weakening of the laser beam, and hence introduced additional measurement error.

As herein demonstrated, the forward modeling method estimates the PSD from the measured CLD using an FBRM instrument. The forward modeling method is an improvement over the traditional inverse modeling method which inverts the matrix relating PSD to CLD based on a given crystal shape. The proposed direct method assumes a probability density function for the PSD from which the corresponding CLD can be easily calculated. Estimates of the unknown parameters are then obtained by minimizing the error between the measured CLD and the calculated one. One advantage of the forward modeling method is that it does not need to invert the ill-conditioned conversion matrix. As a result, the solution does not have an oscillatory behavior when one is not warranted and avoids altogether the calculation of negative number of particles for a given size range.

In all of the simulated cases, forward modeling method data demonstrates exceptional correlated with the answer, whereas the regularization method failed to accurately estimate the PSD in most cases. The biggest differentiation between the two approaches lies in that the forward modeling method is capable of restoring the original PSD even when more than one crystal system with different shapes is present (e.g., case

IV and V). In addition, case IV demonstrated that the forward modeling method was not sensitive to slight changes in aspect ratio of crystals. Therefore, the forward modeling method is applicable when studying the complex crystallization kinetics in systems with secondary nucleation, polymorphic transformation, and/or when more than one diastereomer is present.

It may be suggested that the calculations in case I through V are biased since both the original and the estimation only assumed normally distributed function. In some embodiments, to bypass such a contention, case VI to VIII applied three overall PSDs that were composed of different unknown probability distributions to further test the general applicability of the forward modeling method. In some embodiments, in order to accommodate the unknown variables (e.g., number and type of probability density function used), the forward modeling method was slightly modified. In some embodiments, the first modification was to select generalized probability density function that had the potential to best describe other distribution, wherein it was chosen to use the 3-parameter Gamma distribution. In some embodiments, the second step was to add an iterative process in which the number of Gamma distribution used in the calculation was incremental until the error between the estimated and the calculated CLD met specification.

In some embodiments, the modified forward modeling method successfully back calculates the PSD, as seen in both Case VI and VII. However, it was shown in Case VIII that the forward modeling method also had its limitation. For example, in the case where four distributions were used to construct the PSD, the forward modeling method showed that more than one solution was potentially available for the same optimization problem. Fortunately, it is very rare to have such complicated PSD in real life, and hence, the forward modeling method obtains real-time PSD information that is required to obtain detailed crystallization kinetics. Finally, the forward modeling method was compared with real FBRM measurements from a complex crystallization system. In the first sample in which the measured slurry density was low, the converted PSD from the forward modeling method agreed well with the measured PSD. However, in the second sample in which the measured slurry density was high, the estimated PSD underestimated the particle size.

The underestimation of particle size, caused by the sensitive F-fine mode electronic signal processing in which the FBRM either accepts measurement noise as chord length measurement or surface roughness of the needles, causes the signal of a single chord length to split into two measurements. In either case, the FBRM introduces additional measurement noise that underestimates the chord length of the system. It is noted that the regularization method underestimates the particle size in both cases. The forward modeling method can easily be applied on-line for modeling and control purposes. In some embodiments, drawbacks of FBRM are compensated for when on-line imaging is combined with the forward modeling method. The image analysis guides the forward modeling method to use appropriate aspect ratios of the crystal overtime instead of assuming constant aspect ratio through the experiment. Moreover, in some embodiments, the forward modeling method is used to update the crystallization kinetic model in real time to improve model accuracy.

Any of the methods describe herein may be carried out by a processor residing in a computing device, including, but not limited to, personal computers, hand-held devices, industrial equipment housing a processor, and the like.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A method for calculating particle size distribution in a sample with different particles shapes comprising converting chord length distribution data obtained from a sample to particle size distribution utilizing the forward particle size distribution method, thereby calculating particle size distribution is a sample with different particles shapes.

2. The method of claim 1, wherein the method comprises the steps of: a) construction of a matrix for estimating the chord length distribution (CLD) given a particle side distribution (PSD) for crystals with a known crystal shape; b) assuming a probability density function representative of the true PSD; and c) estimating parameters in a probability density function by minimizing error between a measured CLD and the calculated CLD by multiplying the matrix with the probability density function.

3. The method of claim 2, wherein step a) comprises rotating a three-dimensional geometric object that approximates the known crystal shape, in space, to obtain a chord length distribution.

4. The method of claim 1, wherein the method comprises the steps of: a) calculating a conversions matrix P using Equation 1 to generate different sizes of 3D objects that approximate the particles and calculate chord length distribution (CLD)s with a given particle shape:
$${\vert \frac{x}{a} \vert}^{k} + {\vert \frac{y}{b} \vert}^{k} + {\vert \frac{z}{c} \vert}^{k} = 1 \qquad ( equation 1 )$$
where a, b, and c indicate the half-length of the three primary axes, and wherein the values of the exponent k represents the sharpness of the corners;
b) selecting a probability density function that might best describe the true particle side distribution (PSD); and c) estimating parameters of the selected probability density function that give a minimal error residual between the estimated and measured CLD using Equation 8:
$${min}_{d} ‖ Pf ( d ) - c ‖$$
wherein P is the conversion matrix,
wherein f is the probability density function,
wherein d is the variable of the unknown distribution parameters, and
wherein c is the measured data.

5. The method of claim 1, where the sample comprises crystals with different shapes.

6. The method of claim 1, wherein the sample comprises crystals with secondary nucleation.

7. The method of claim 1, wherein the sample comprises crystals with polymorphic transformation.

8. The method of claim 1, wherein the sample comprises crystals with more than one diastereomer present.

9. A system comprising a computer having a processor, said processor configured to carry out the method of any of claims 1 through 8.
